(19) United States
(12) Patent Application Publication
(10) Pub. No.: US 2010/0010142 A1
(43) Pub. Date: Jan. 14, 2010

(54) COMPOSITION OF POLYPROPYLENE RESIN HAVING LOW SHRINKAGE AND DIMENSIONAL STABILITY

(75) Inventors: Jung Gyun NOH, Gyeonggi-do (KR); Chi Hoon CHOI, Gyeonggi-do (KR); Beom Ho KIM, Chungcheongnam-do (KR); Byung Woo AHN, Incheon (KR); Hyeon Don KIM, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/368,642

(22) Filed: Feb. 10, 2009

(30) Foreign Application Priority Data
Jul. 11, 2008 (KR) 10-2008-0067655

(51) Int. Cl. C08K 3/34; C08L 23/12; C08L 51/00

(52) U.S. Cl. 524/451; 524/528; 524/504; 296/1.08

(57) ABSTRACT

The present invention relates to polypropylene-based composite resin composition for an automotive interior trim. The polypropylene-based composite resin composition herein has relatively high rigidity and surface impact and relatively low molding shrinkage and coefficient of linear expansion, thus having superior dimensional stability.

### CROSS-REFERENCE TO RELATED APPLICATION

This application claims the benefit under 35 U.S.C. §119(a) of Korean Patent Application No.10-2008-0067655 filed on Jul. 11, 2008, the entire contents of which are incorporated herein by reference.

### BACKGROUND

(a) Technical Field

The present invention relates to polypropylene-based composite resin composition for an automotive interior trim. The polypropylene-based composite resin composition herein has relatively high rigidity and surface impact and relatively low molding shrinkage and coefficient of linear expansion, thus having superior dimensional stability.

In particular, the polypropylene-based composite resin of the present invention preferably comprises (a) composite resin comprising (i) polypropylene resin of at least one selected from the group consisting of, but not limited to, propylene homopolymer, propylene ethylene copolymer and highly crystalline polypropylene, (ii) ethylene-a-olefin copolymer comprising a blend of ethylene-propylene copolymer rubber and ethylene-a-olefin copolymer, and (iii) inorganic filler; and (b) a particular amount of polypropylene comprising 30-80% of C₂ or higher co-monomer suitably prepared in three or more gas-phase reactors, thereby increasing dimensional stability.

(b) Background Art

With the trend toward the lighter-weight automobiles, plastics have been widely used in bumpers and interior parts. In particular, polypropylene shows relatively low density and considerable moldability, thermal resistance and chemical resistance. Thus, polypropylene is already widely used in non-painted interior parts such as instrument panels, door trims and pillar trims. For the purpose of achieving lighter weight and cost reduction, non-painted polypropylene-based instrument panels and invisible passenger air bag (PAB) instrument panels are introduced by replacing the conventional PC/ABS and polyurethane materials with suitable polypropylene-based composite resins.

Thin products with wide surface areas like an instrument panel preferably show relatively higher fluidity and rigidity for moldability, and should preferably also satisfy impact resistance for stability and scratch resistance and glossless property for preferably for aesthetic appeal. However, it can be difficult to meet with the aforementioned properties by using polypropylene-based composite material. At present, non-painted polypropylene-based composite material is only used for moderate- or low-priced automobiles, and high-priced cars employ the conventional PC/ABS substrate in combination with thermoset semi-rigid polyurethane foam and ABS, PVC, TPO, TPU sheets.

Therefore, in order to suitably replace the conventional PC/ABS instrument panel substrate, polypropylene-based composite material should overcome the problems of resin dimension problem and matching with polyurethane foam and Sheet. Therefore, there are needs for the development of polypropylene-based composite material that can immediately replace the conventional material without addition of expense and processes.

Accordingly, polypropylene-based composite material suitably similar to the conventional PC/ABS in dimensional stability and rigidity, impact resistance, low shrinkage and low coefficient of linear expansion have recently been introduced. For example, Korean patent Nos. 033557 and 059003 are directed to inventions showing impact resistance, low shrinkage and low coefficient of linear expansion where needle-shaped calcium-meta-silicate-based wollastonite was used as an inorganic filler and ethylene-propylene copolymer rubber (EPR) (propylene content of 20-50 wt %) and ethylene-octene copolymer rubber (EOR) (octene content of 20-30 wt %) were used as an rigidity enhancer.

Korean patent No. 0535611 is directed to an invention showing balance between impact resistance and rigidity and superior scratch resistance and molding shrinkage where needle-shaped silica and talc were used as inorganic filler, polypropylene master batch was prepared by cross-linking propylene-ethylene copolymer and ethylene-propylene rubber with organic peroxides, and EPR and EOR were used as a rigidity enhancer. Further, Korean patent No. 0714193 is directed to an invention that improved rigidity and low shrinkage by using magnesium whisker.

However, when needle-shaped calcium-meta-silicate-based wollastonite is used, as disclosed in Korean patent Nos. 033557 and 059003, bent deformation can be generated due to the orientation of fillers during the injection and impact resistance can be deteriorated. Rubber ingredient added for improving impact resistance can decrease scratch resistance. When inorganic filler is used for decreasing molding shrinkage, weight can be increased and appearance quality can be deteriorated, thus lowering impact strength.

A mixture of needle-shaped silica and talc used as inorganic filler as disclosed in Korean patent No. 0535611 can considerably decrease processability. Master batch prepared by cross-linking propylene-ethylene copolymer and ethylene-propylene rubber used as rigidity enhancer can also decrease the ratio of the increase in rigidity to the decrease in impact resistance, thus being inadequate in economical respect.

When whisker disclosed in Korean patent No. 0535611 is preferably used as inorganic filler, impact resistance, moldability and appearance quality can be considerably deteriorated although molding shrinkage and rigidity may be improved.

As mentioned above, although the conventional use of needle-shaped inorganic filler for controlling shrinkage can improve molding shrinkage as equivalent to PC/ABS, there are still considerations related to shrinkage and the gap that forms during injection of instrument panel that may result in considerable dimension difference under severe thermal conditions, and subsequently may result in lowered product quality.

The above information disclosed in this the Background section is only for enhancement of understanding of the background of the invention and therefore it may contain information that does not form the prior art that is already known in this country to a person of ordinary skill in the art.

### SUMMARY OF THE DISCLOSURE

The present invention provides polypropylene-based composite materials that are superior in moldability (fluidity), rigidity, impact resistance (stability), scratch resistance (emotional quality) and non-glossy property, which are useful for thin products with wide surface area such as an instrument panel.

According to preferred embodiments of the invention, in order to develop a polypropylene-based composite resin that is suitably similar to non-crystalline polymeric material (PC/ABS) in properties such as molding shrinkage and dimensional stability, and also suitably satisfies low coefficient of linear expansion considering post-deformation after the injection, the present invention is preferably directed to polypropylene-based composite resin compositions that are remarkably improved in dimensional stability, low coefficient of linear expansion, low shrinkage, rigidity and impact resistance. In preferred embodiments, this polypropylene-based composite resin is suitably prepared by using a composition that comprises polypropylene preferably comprising propylene homopolymer or propylene ethylene copolymer and highly crystalline polypropylene or a mixture thereof, ethylene-a-olefin copolymer comprising a mixture of ethylene-propylene copolymer rubber and ethylene-a-olefin copolymer, and a particular amount of inorganic filler; and polypropylene elastomer comprising, preferably, 30-80% of C₂ or higher co-monomer in three gas-phase reactors.

According to preferred embodiments, the composite resin of the present invention is superior in rigidity, impact resistance balance and surface impact resistance, and also preferably satisfies low shrinkage and low coefficient of linear expansion property, thus being capable of suitably replacing the conventional non-crystalline polymeric material such as PC/ABS used for automotive instrument panel and other interior parts.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a windshield member (W/SHIELD);

FIG. 2 is A-PILLAR member; and

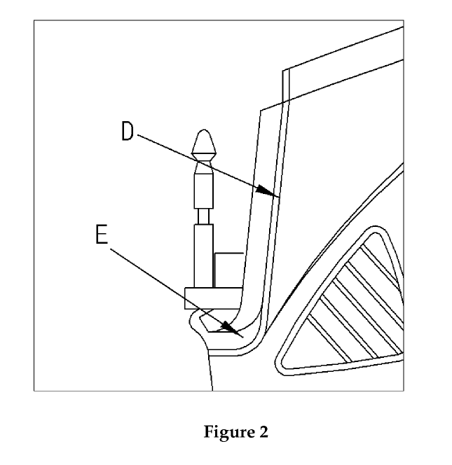

FIG. 3 is C/PAD MAIN member.

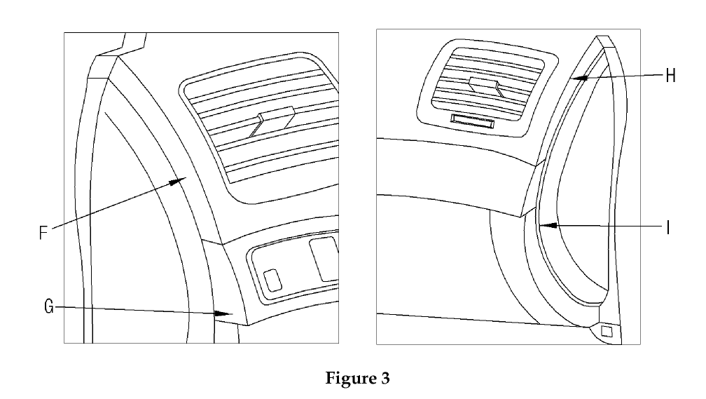

Reference numerals set forth in the Drawings includes reference to the following elements as further discussed below:

A, B, C, D, E, F, G, H and I are the positions where deformation was measured.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention features a polyolefin-based resin composition for an automotive interior trim, the composition preferably comprising a propylene polymer with a melt flow index of 0.5-100 g/10 minutes, a blended ethylene-a-olefin copolymer comprising an ethylene-propylene copolymer rubber and an ethylene-a-olefin copolymer, a polypropylene elastomer, an inorganic filler; and a modified polypropylene with a functional group.

In preferred embodiments, the propylene polymer in the composition is 35-75 parts by weight.

In other preferred embodiments, the blended ethylene-a-olefin copolymer in the composition is 5-30 parts by weight.

In still other embodiments, the polypropylene elastomer in the composition is 5-35 parts by weight.

In related embodiments, the inorganic filler in the composition is 0-40 parts per weight.

In other embodiments, the modified polypropylene in the composition is 0-5 parts per weight. In further related embodiments, the modified polypropylene further comprises a functional group.

In other embodiments, the propylene polymer has a melt flow index of 0.5-100 g/10 minutes.

In particular preferred embodiments, the propylene polymer is at least one polymer selected from the group consisting of: a propylene homopolymer, a propylene ethylene copolymer and a highly crystalline polypropylene.

The present invention also features a motor vehicle that comprises a polyolefin-based resin composition for an automotive interior trim as described in any one of the aspects herein.

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

In preferred aspects, the present invention relates to a polypropylene-based resin composition comprising (a) a polypropylene resin, preferably 30-70% of a polypropylene resin, of at least one selected from the group consisting of, but not limited to, propylene homopolymer or propylene ethylene copolymer and highly crystalline polypropylene; (b) ethylene-α-olefin copolymer blend, preferably 5-30% of ethylene-α-olefin copolymer blend of ethylene-propylene copolymer rubber and ethylene-α-olefin copolymer; (c) inorganic filler, preferably 0-40% of an inorganic filler; (d) modified polypropylene, preferably 0-5% of a modified polypropylene 0-5%, in further preferred embodiments with functional groups preferably introduced for improving the compatibility between polypropylene and the inorganic filler; and (e) polypropylene elastomer, preferably 5-35% of polypropylene elastomer, in further preferred embodiments where 30-80% of C2 or more co-monomer is contained in three or more gas-phase reactors.

In preferred embodiments, the present invention also relates to a polyolefin-based resin composition for an automotive interior trim, which preferably comprises 35-75 parts by weight of a propylene polymer with a melt flow index of 0.5-100 g/10 minutes; 5-30 parts by weight of an ethylene-α-olefin copolymer blend of ethylene-propylene copolymer rubber and ethylene-α-olefin copolymer; 5-35 parts by weight of polypropylene elastomer; 0-40 parts by weight of inorganic filler; and 0-5 parts by weight of a modified polypropylene with functional groups introduced.

Described herein is an exemplary description of the present invention. In preferred embodiments, the present invention relates to a polypropylene composite resin comprising:

(A) ethylene-propylene copolymer, preferably 35-75 wt % of ethylene-propylene copolymer, in certain preferred embodiments that is selected among propylene homopolymer or propylene ethylene copolymer and highly crystalline polypropylene having a melt flow index of 0.5-100 g/10 minutes (230° C., 2.16 kg) and an ethylene-propylene rubber, preferably with a content of 0.5-15 wt %;

(B) ethylene-propylene copolymer rubber, preferable 0-20% of an ethylene-propylene copolymer rubber (EPR) with a propylene content of 20-50%, a melt index of 0.5-6.0 (230° C., 2.16 kg) and a Mooney viscosity of 5-60 ML 1+4.

(C) polypropylene elastomer, preferably 5-35% of polypropylene elastomer (Basell's Catalloy) where dispersibility and content of rubber in polypropylene matrix is suitably maximized by directly reacting ethylene-propylene rubber and ethylene-butylene rubber with up to 20-85% of homopolypropylene in three gas-phase reactors,

(D) inorganic filler, preferably 10-40% of an inorganic filler selected from the group consisting of talc, calcium carbonate, glass fiber, wollastonite, magnesium whisker and barium sulfate,

(E) modified polypropylene, preferably 0-5% of a modified polypropylene that is in preferred embodiments grafted with carboxylic group to increase binding force between the surfaces of non-polar polyolefin and the inorganic filler.

In further preferred embodiments, other additives such as, but not limited only to, antioxidants, UV absorbing agents, photostabilizers, pigments, dispersing agents, nucleating agents, lubricants and coupling agents can be added for improving performance of molded products and process characteristics.

As described herein, the present invention relates to polyolefin-based resin composition for an automotive interior trim where the propylene polymer is preferably one or more selected from the group consisting of propylene homopolymer, propylene ethylene copolymer and highly crystalline polypropylene.

In particular preferred embodiments, the present invention relates to polyolefin-based resin composition for an automotive interior trim where in further preferred embodiments, the propylene homopolymer has an isotactic index of 94-97%.

In more particular preferred embodiments, the present invention relates to polyolefin-based resin composition for an automotive interior trim where the propylene ethylene copolymer comprises 0.5-30 wt % of ethylene-propylene rubber with ethylene content of 1-50 wt %.

In more particular preferred embodiments, the present invention relates to polyolefin-based resin composition for an automotive interior trim where the highly crystalline polypropylene preferably has an isotactic index of 98.5-100%, and is a copolymer between propylene homopolymer or propylene and C₂-C₁₀ monomer.

In related embodiments, the ingredient (A), propylene polymer, comprises one or more selected from the group consisting of, but not limited to, propylene homopolymer, propylene ethylene copolymer and highly crystalline polypropylene.

Preferably, the propylene homopolymer has an isotactic index of 94-97% (C¹³-NMR measurement), a weight at 230° C. of 2.16 kg and a melt flow index of 0.5-100 g/10 minutes.

Preferably, the propylene ethylene copolymer has an ethylene-propylene rubber content of 0.5-30 wt % and a melt flow index of 0.5-100 g/_{10 minute}, and suitably comprises ethylene (1-50 wt %) and propylene (50-99 wt %).

Preferably, the highly crystalline polypropylene has an isotactic index (C¹³-NMR measurement) of 98.5%, a melt flow index of 0.5-100 g/_{10 minutes}, and a copolymer between propylene homopolymer or propylene and C₂-C₁₀ monomer. Preferably, the content of C₂-C₁₀ monomer is suitably maintained within the range of 0-40 mol %, 0-20 mol %., preferably 0-10 mol % to suitably maintain impact resistance and rigidity balance of highly crystalline polypropylene. In certain preferred embodiments, when the isotactic index of the highly crystalline ethylene-propylene copolymer is less than 97%, the rigidity and surface rigidity of molded products may be unsatisfactory. When the melt flow index is less than 5 g/_{10 minutes}, fluidity and moldability can be suitably insufficient. When the melt index is higher than 40 g/10 minutes, the impact resistance of molded products can considerably decrease.

In further preferred embodiments, the three kinds of propylene polymers are preferred to be suitably mixed appropriately for required performance because impact resistance and surface gloss of products are suitably increased when only the propylene homopolymer is used.

In certain preferred embodiments of the present invention, the blended ethylene-α-olefin copolymer is preferably a blend of an ethylene-propylene copolymer rubber with a melt index of 0.5-6.0 (230° C., 2.16 kg) and Mooney viscosity of 5-70 ML 1+4 and an ethylene-α-olefin copolymer with Mooney viscosity of 5-60 ML 1+4.

In further preferred embodiments, the ingredient (B), ethylene-α-olefin copolymer, is a rubber polymerized in the presence of metallocene-based catalyst. Preferably, butene (EBR) and octene (EOR) are mainly used as α-olefin in the amount of 20-50 wt %, preferably 30-45 wt %. Mooney viscosity of the α-olefin is 5-60 ML1+4, preferably 20-40 ML1+4 at 121° C..

In related embodiments, when Mooney viscosity is lower than 5, properties can be unsatisfactory, while processability can be suitably deteriorated when the viscosity is higher than 50. Preferably, the glass transition temperature of the polymer is preferred to be within the range from −50° C. to −65° C.. Accordingly, when glass transition temperature is higher than −50° C., resistance to impact at a low temperature can be unsatisfactory. When glass transition temperature is lower than −65° C., rigidity and thermal resistance can be deteriorated. In further preferred embodiments, the content of ethylene-α-olefin copolymer is 5-30 wt %, preferably 10-20 wt % relative to the total weight of polypropylene composite resin. According to related embodiments, when the content is less than 5 wt %, surface impact strength can be unsatisfactory. According to other related embodiments, when the content is higher than 30 wt %, strength and thermal resistance can be deteriorated.

Preferably, the ethylene-propylene copolymer rubber (EPR) has a propylene weight of 20-50%, a melt index of 0.5-6.0 (230° C., 2.16 kg) and Mooney viscosity of 5-70 ML 1+4 preferably 15-50 ML 1+4. When Mooney viscosity is higher than 70, appearance and mechanical properties can be unsatisfactory because moldability and dispersibility in polypropylene matrix can be suitably deteriorated. When Mooney viscosity is lower than 15, impact resistance can be unsatisfactory.

Preferably, an optimum blending ration of the two kinds of rubber needs to be obtained considering rigidity, impact resistance, surface impact and molding shrinkage balance because rigidity or impact resistance can be unsatisfactory if only one the two kinds of rubber (ethylene-α-olefin copolymer and ethylene-propylene rubber) is used. According to further preferred embodiments of the invention, preferable blending ratio between ethylene-propylene rubber and ethylene-α-olefin copolymer is 40-70: 50-5 wt %, more preferably 50-65: 35-50 wt % considering property balance.

According to preferred embodiments of the present invention, the polypropylene elastomer is a polypropylene elastomer selected from the group consisting of, but not limited to, a polypropylene elastomer comprising 55-75 wt % of C₂-C₄ bipolymer copolymer rubber, 50-70 wt % of a polypropylene elastomer comprising C₂-C₃ bipolymer copolymer rubber and a mixture thereof.

Preferably, as an important ingredient in the present invention, the ingredient (C), polypropylene elastomer, is a polypropylene copolymer prepared by directly reacting ethylene-propylene rubber and ethylene-butylene rubber with up to 20-85% of homopolypropylene in three a gas-phase reactor to suitably maximize rubber dispersibility and content in polypropylene matrix. Preferably, for achieving suitably low shrinkage and suitably low linear expansion coefficient, the polypropylene elastomer is preferred to be selected from the group consisting of, but not limited to, a polypropylene elastomer comprising 55-75 wt % of a C₂-C₄ bipolymer copolymer rubber, a polypropylene elastomer comprising 50-70 wt % of a C₂-C₃ bipolymer copolymer rubber and a mixture thereof. The ingredient (C) is used in the amount of 5-35 wt %, preferably 10-30 wt % relative to the total weight of resin composition.

According to preferred embodiments of the invention as described herein, when the content of C₂-C₄ copolymer rubber is less than 60 wt %, impact resistance and shrinkage can be suitably unsatisfactory. When the content is more than 75 wt %, rigidity and moldability can be suitably decreased. When the content of C₂-C₃ copolymer rubber is less than 50 wt %, impact resistance and coefficient of linear expansion can be suitably decreased. When the content is more than 70 wt %, rigidity can be unsatisfactory and flow mark can be suitably generated.

Therefore, according to further preferred embodiments, to maintain a low linear expansion coefficient and property balance, it is preferred to use C₂-C₄ copolymer rubber only or a combination of C₂-C₄ and C₂-C₃ in a blending ratio of 50-90 wt %: 10-50 wt %.

In preferred embodiments of the present invention, the inorganic filler comprises talc with an average particle size of 0.5-10 μm.

Preferably, the ingredient (D), inorganic filler, is added to suitably enhance rigidity, and plate-shaped talc with an average particle size of 0.5-10 μm is used in the amount of 0-50 wt %, 0-40 wt %, preferably 0-30 wt %. When the average particle size is greater than 10 μm, mechanical property can suitably deteriorate and molding shrinkage can be generated. When the average particle size is smaller than 0.5 μm, processability can be suitably decreased. Other additives such as, but not limited to, wollastonite, barium sulfate, calcium carbonate, silica, mica, calcium silicate, magnesium whisker and glass fiber can also be used in the amount of 0-10 wt % relative to the total weight of polypropylene composite resin.

In certain preferred embodiments of the present invention, the modified polypropylene is prepared by grafting polypropylene copolymer with one or more selected from the group consisting of, but not limited only to, unsaturated carboxylic acid, maleic acid, acrylic acid, methacrylic acid and anhydrous maleic acid.

According to certain exemplary embodiments, as the ingredient (E) used to increase the surface binding force between non-polar polyolefin and inorganic filler, modified polypropylene grafted with carboxylic group is preferably used in the amount of 0.1-10 wt %, preferably 0.5-5 wt %. According to further preferred embodiments, the modified polypropylene is suitably prepared by grafting polypropylene copolymer with unsaturated carboxylic acid or one or more derivatives thereof selected from the group consisting of, but not limited to, maleic acid, acrylic acid, methacrylic acid, anhydrous maleic acid, dimethylolparaoctylphenol. Accordingly, when the degree of graft is less than 0.5 wt %, the binding force between polypropylene and inorganic filler can be insufficient, thus deteriorating mechanical properties.

According to further preferred embodiments of the invention, resin composition of the present invention further comprises, but is not limited only to, additives such as primary or secondary antioxidants, UV absorbing agents, photostabilizers, pigments, dispersing agents, nucleating agents, lubricants and coupling agents for improving performance of products and processability.

In the present invention, according to certain embodiments, raw materials can be mixed with a super mixer and supplied. Alternatively, raw materials can be supplied through different inlets in a particular ratio. For example, a mixer such as a uniaxial extruder, a biaxial extruder and banbury mixer can be used as a processing device in the present invention. According to preferred embodiments, usually, pellet-shaped compound is prepared by blending raw materials with a biaxial extruder.

According to exemplary embodiments of the present invention, specimens were prepared by using a biaxial extruder (diameter 40 mm, L/D 52) at 190-210° C. and screw rotation speed of 200-400 rpm.

### EXAMPLES

The following examples illustrate the invention and are not intended to limit the same.

### Preparatory Example: Preparation of Test Specimens

According to a preferred exemplary embodiment, composite resin composition was prepared as ingredients and contents are shown in Table 1. Test specimens were prepared by injection molding the composite resin composition in an injection molder (model: LGE110, LS Cable Ltd.). Cylinder temperature was 220° C. and mold temperature was 50° C..

TABLE 1

| | | Examples (wt %) | | | | Comparative Examples (wt %) | | | | | |
|---|---|---|---|---|---|---|---|---|---|---|---|
| Ingredients | | 1 | 2 | 3 | 4 | 1 | 2 | 3 | 4 | 5 | 6 |
| A | PP1 | 41 | — | 23 | 38 | 44 | 28 | — | 28 | 43 | 41 |
| | PP2 | — | 24 | — | — | — | — | — | 10 | — | — |
| | PP3 | — | 16 | 15 | — | — | — | 39 | — | — | — |
| B | EOR1 | — | 6 | — | — | — | — | 7 | — | — | 5 |
| | EBR1 | 5 | — | 5 | — | 11 | — | 7 | — | — | 5 |
| | EPR1 | 7 | 7 | 5 | 5 | 13 | — | — | 15 | 7 | 7 |
| C | CP1 | 15 | — | 20 | — | — | 40 | — | — | 15 | 15 |
| | CP2 | — | 15 | — | 30 | — | — | 15 | 15 | — | — |
| D | M1 | 30 | 30 | 30 | 25 | 30 | 30 | 30 | 30 | 30 | 20 |
| | M2 | — | — | — | — | — | — | — | — | — | 10 |
| E | MgP | 2 | 2 | 2 | 2 | 2 | 2 | 2 | 2 | — | 2 |

### A) Polypropylene

TABLE 2

| Ingredients | PP-1 | PP-2 | PP-3 |
|---|---|---|---|
| MI (g/10 min) | 30 | 30 | 27 |
| Mw (g/mol) | 221,000 | 210,000 | 195,000 |
| Ec (wt %) | 8 | 8 | 0 |

1. PP-1: highly crystalline polypropylene, isotacticity of higher than 98.5
2. PP-2: propylene-ethylene copolymer
3. PP-3: propylene homopolymer
4. MI: melt index measured according to ASTM D1238 (230° C., 2.16 kg)
5. Mw: weight average molecular weight
6. Ec: ethylene content

### B) Impact Enhancer

TABLE 3

| Ingredients | EOR 1 | EBR 1 | EPR 1 |
|---|---|---|---|
| Mooney viscosity | 26 | 7 | 69 (at 100° C.) |
| (ML1 + 4 at 121° C.) | | | |
| Co-monomer content | 45 (octene) | 42 (butene) | 32 (propylene) |

1. EOR: ethylene-octene rubber
2. EBR: ethylene-butene rubber
3. EPR: ethylene-propylene copolymer rubber

### C) Polypropylene Elastomer

TABLE 4

| Ingredients | CP1 | CP2 |
|---|---|---|
| Co-monomer content | 70 | 56 |
| Kind of co-monomer | C₂-C₃ rubber | C₂-C₄ rubber |
| MI | 7 | 4 |

1. CP1, CP2: polypropylene elastomer, Basell's catalloy

### D) Inorganic Filler

TABLE 5

| Ingredients | M1 | M2 |
|---|---|---|
| Particle size (μm) | 0.5-2 | 10-13 |

1. M1: IMFABI's Fine talc
2. M2: KOCH

### E) Modified Polypropylene

Polar polypropylene (degree of graft: 1.5 wt %) prepared by grafting propylene homopolymer with unsaturated carboxylic acid was used as modified polypropylene.

### Test Example 1

### Measurement of Mechanical Properties and Coefficient of Linear Expansion

Properties were measured by using specimens prepared in Examples 1-4 and Comparative Examples 1-6, and the results are provided in Table 7. The test method and conditions are described below.

(1) Melt index was measured according to ASTM D-1238. Test conditions: 230° C. and 2.16 kgf

(2) Flexural modulus was measured according to ASTM D-790. Specimen dimensions: 12.7*127*6.4 mm; Test conditions (crosshead speed): 30 mm/min

(3) Tensile strength was measured according to ASTM D-638. Test conditions: 30 mm/min; Guage length: 50 mm

(4) IZOD impact strength was measured according to ASTM D-256. Specimen dimensions: 63.7*12.7*3 mm

(5) Thermal deformation temperature was measured according to ASTM D-648. Specimen dimensions: 12.7*127*6.4 mm; Test load: 4.6 kgf

(6) Molding shrinkage was obtained by measuring initial length and shrunk length 24 hours after the injection molding in the unit of 1/1000. ASTM tensile specimens were used.

(7) Coefficient of linear expansion (CLTE) was measured according to ASTM D-696 in the temperature range of −30-80° C. by using TMA.

(8) Surface impact (falling impact strength) was measured according to ASTM D-1794 by using 10*10*0.3 specimens.

TABLE 7

| | | Examples (wt %) | | | | Comparative Examples (wt %) | | | | | |
|---|---|---|---|---|---|---|---|---|---|---|---|
| Properties | | 1 | 2 | 3 | 4 | 1 | 2 | 3 | 4 | 5 | 6 |
| MI | | 13 | 14 | 13 | 12 | 14 | 11 | 13 | 7 | 13 | 13 |
| (g/10 min) | | | | | | | | | | | |
| Tensile strength | | 210 | 205 | 207 | 200 | 180 | 195 | 225 | 195 | 198 | 192 |
| (kgf/cm2) | | | | | | | | | | | |
| Flexural modulus | | 21000 | 20500 | 21700 | 20600 | 18500 | 17900 | 20600 | 21700 | 19700 | 18600 |
| (kgf/cm2) | | | | | | | | | | | |
| Thermal deformation | | 125 | 124 | 126 | 123 | 125 | 121 | 118 | 122 | 117 | 116 |
| temperature (° C.) | | | | | | | | | | | |
| IZOD | 23° C. | 55 | 53 | 52 | 55 | 53 | 47 | 38 | 45 | 46 | 35 |
| (kgcm/cm) | −30° C. | 6.6 | 6.4 | 6.5 | 6.4 | 6.7 | 5.9 | 4.5 | 6.7 | 5.9 | 5.1 |

| | | | | | | | | | | |
|---|---|---|---|---|---|---|---|---|---|---|
| Surface impact | 240 | 225 | 240 | 270 | 210 | 210 | 150 | 210 | 195 | 180 |
| (kg · cm) | | | | | | | | | | |
| Shrinkage | 4.2 | 4.4 | 4.2 | 4.1 | 5.2 | 4.5 | 5.0 | 4.9 | 4.6 | 6.0 |
| (1/1000) | | | | | | | | | | |
| Coefficient of linear | 5.8 | 6.0 | 5.9 | 5.7 | 7.6 | 6.3 | 6.8 | 6.5 | 7.2 | 7.1 |
| Expansion (mm/mm/° C.) | | | | | | | | | | |

As shown in Table 7, resin composition of Examples 1-4 was similar to PC/ABS in mechanical properties and dimensional stability (shrinkage and coefficient of linear expansion). Resin composition of Examples 1-4 satisfied rigidity, impact strength and surface impact, which are required of instrument panel substrate. Resin composition of Examples 1-4 was ascertained as superior in coefficient of linear expansion and molding shrinkage, which shows dimensional stability.

In contrast, as shown in Comparative Example 1, where only ethylene-propylene copolymer rubber and ethylene-butene rubber were added in the absence of polypropylene elastomer, rigidity was decreased while shrinkage and coefficient of linear expansion were increased, thus deteriorating dimensional stability. When the content of polypropylene elastomer is too high as in Comparative Example 2, rigidity was insufficient, thus being inappropriate for an instrument panel substrate. When only polypropylene homopolymer was used as in Comparative Example 3, impact resistance and surface impact were drastically decreased, thus deteriorating dimensional stability. When ethylene-propylene copolymer rubber was used as in Comparative Example 4, fluidity was drastically decreased, thus generating significant amount of flow marks during the injection. When no functional group was introduced as in Comparative Example 5, the binding force between polypropylene and inorganic filler was decreased, thus deteriorating properties. Dimensional stability was decreased due to relatively high coefficient of linear expansion. When talc with relatively large particle size was used as in Comparative Example 6, total surface of inorganic filler was decreased and crack rapidly proceeds, thus decreasing mechanical properties and dimensional stability.

### Test Example 2

### Test of Deformation Behavior

To evaluate the effect of molding of secondary product on post-deformation, products injection-molded by using composition prepared in Example 1 and Comparative Example 1 were stored at room temperature for 24 hours. After the thermal treatment of foamed surface, the products were mounted on JIG for measuring dimensions. The results of deformation were provided in Table 8 as Example 1 and Comparative Example 1, respectively. The results of commercially available PC/ABS were also presented in Table 8.

Injection was conducted by using a 3000 t injection device (MEKEI) at the temperature of 190-230° C. and a maximum pressure of 135 MPa. Cycle time was 80 seconds and product standard weight was 3450 g.

Flame process is comprised of a primary washing step, a secondary washing step, a step of spraying an antistatic agent, a step of primer and a drying step (60° C., 30 minutes).

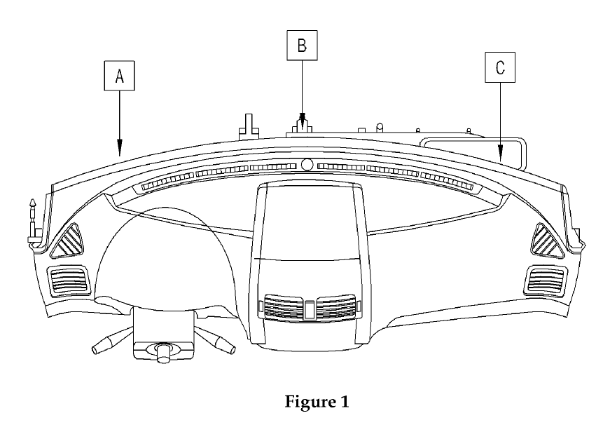

Deformation was measured at eight positions, and the results are presented in Table 8. When considering shrinkage, the difference between JIG prepared the same with the shape of a molder and GAP due to the deformation of molded products was shown in the unit of mm. FIG. 1 is the photograph of the positions where dimensions were measured.

TABLE 8
Measured dimensions

| | Position | | | | | | | | | |
|---|---|---|---|---|---|---|---|---|---|---|
| | A | B | C | D | E | F | G | H | I | Appearance |
| Member | W/SHIELD | | | A-PILLAR | | C/PAD MAIN | | | | |
| Standard | 3.0 ± 1.0 | 3.0 ± 1.0 | 3.0 ± 1.0 | 3.0 ± 1.0 | 3.0 ± 1.0 | 5.0 ± 1.0 | 5.0 ± 1.0 | 5.0 ± 1.0 | 5.0 ± 1.0 | — |
| SPEC | | | | | | | | | | |
| PC/ABS | 3.3 | 4.8 | 3.8 | 2.8 | 3.5 | 4.4 | 4.3 | 5.3 | 5.3 | Excellent |
| Ex. 1 | 3.4 | 4.9 | 3.7 | 2.5 | 3.6 | 4.2 | 4.3 | 5.5 | 5.3 | Excellent |
| Comp. Ex. 1 | 3.8 | 5.8 | 4.5 | 3.3 | 4.3 | 5.8 | 4.8 | 6.1 | 5.9 | Good |

As shown in Table 8, the measured dimensions according to Example 1 where polypropylene elastomer was added were superior and closer to standard specifications after the injection process (after the painting process) compared with Comparative Example 1 where no polypropylene elastomer was added. Example 1 also shows dimension results similar to PC/ABS.

These results demonstrate that polypropylene elastomer causes low shrinkage and low coefficient of linear expansion (CLTE) properties of composite polypropylene resin composition, thereby improving dimensional stability.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polyolefin-based resin composition for an automotive interior trim, the composition comprising:
(a) 35-75 parts by weight of a propylene polymer with a melt flow index of 0.5-100 g/10 minutes;
(b) 5-30 parts by weight of a blended ethylene-α-olefin copolymer comprising an ethylene-propylene copolymer rubber and an ethylene-α-olefin copolymer;
(c) 5-35 parts by weight of polypropylene elastomer;
(d) 0-40 parts by weight of an inorganic filler; and
(e) 0-5 parts by weight of a modified polypropylene with a functional group.

2. The polyolefin-based resin composition of claim 1, wherein the propylene polymer is at least one polymer selected from the group consisting of a propylene homopolymer, a propylene ethylene copolymer and a highly crystalline polypropylene.

3. The polyolefin-based resin composition of claim 2, wherein the propylene homopolymer has an isotactic index of 94-97%.

4. The polyolefin-based resin composition of claim 2, wherein the propylene ethylene copolymer comprises 0.5-30 wt % of an ethylene-propylene rubber with an ethylene content of 1-50 wt %.

5. The polyolefin-based resin composition of claim 2, wherein the highly crystalline polypropylene has an isotactic index of 98.5-100%, and is selected from the group consisting of a propylene homopolymer and a copolymer of a propylene and a C2-C10 monomer.

6. The polyolefin-based resin composition of claim 1, wherein the blended ethylene-α-olefin copolymer comprises (i) an ethylene-propylene copolymer rubber with a melt index of 0.5-6.0 (230° C., 2.16 kg) and a Mooney viscosity of 5-70 ML 1+4 and (ii) an ethylene-α-olefin copolymer with a Mooney viscosity of 5-60 ML 1+4.

7. The polyolefin-based resin composition of claim 1, wherein the polypropylene elastomer is selected from the group consisting of a polypropylene elastomer comprising 55-75 wt % of a C2-C4 bipolymer copolymer rubber, a polypropylene elastomer comprising 50-70 wt % of a C2-C3 bipolymer copolymer rubber and a mixture thereof.

8. The polyolefin-based resin composition of claim 1, wherein the inorganic filler comprises talc with an average particle size of 0.5-10 μm.

9. The polyolefin-based resin composition of claim 1, wherein the modified polypropylene is a polypropylene copolymer grafted with at least one selected from the group consisting of an unsaturated carboxylic acid, a maleic acid, an acrylic acid, a methacrylic acid and an anhydrous maleic acid.

10. A polyolefin-based resin composition for an automotive interior trim, the composition comprising:
(a) a propylene polymer with a melt flow index of 0.5-100 g/10 minutes;
(b) a blended ethylene-α-olefin copolymer comprising an ethylene-propylene copolymer rubber and an ethylene-α-olefin copolymer;
(c) a polypropylene elastomer;
(d) an inorganic filler; and
(e) a modified polypropylene with a functional group.

11. The polyolefin-based resin composition for an automotive interior trim of claim 10, wherein the propylene polymer in the composition is 35-75 parts by weight.

12. The polyolefin-based resin composition for an automotive interior trim of claim 10, wherein the blended ethylene-α-olefin copolymer in the composition is 5-30 parts by weight.

13. The polyolefin-based resin composition for an automotive interior trim of claim 10, wherein the polypropylene elastomer in the composition is 5-35 parts by weight.

14. The polyolefin-based resin composition for an automotive interior trim of claim 10, wherein the inorganic filler in the composition is 0-40 parts per weight.

15. The polyolefin-based resin composition for an automotive interior trim of claim 10, wherein the modified polypropylene in the composition is 0-5 parts per weight.

16. The polyolefin-based resin composition for an automotive interior trim of claim 15, wherein the modified polypropylene further comprises a functional group.

17. The polyolefin-based resin composition for an automotive interior trim of claim 10, wherein the propylene polymer has a melt flow index of 0.5-100 g/10 minutes.

18. The polyolefin-based resin composition of claim 10, wherein the propylene polymer is at least one polymer selected from the group consisting of: a propylene homopolymer, a propylene ethylene copolymer and a highly crystalline polypropylene.

19. A motor vehicle comprising polyolefin-based resin composition for an automotive interior trim of claim 1.

20. A motor vehicle comprising polyolefin-based resin composition for an automotive interior trim of claim 10.
